(19) United States
(12) Patent Application Publication
(10) Pub. No.: US 2019/0155297 A1
(43) Pub. Date: May 23, 2019

(54) DEVICE FOR GUIDING ROBOT TO RECHARGING BASE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Wen-Juan Liu, Shenzhen (CN); Zhi-Yong Jin, Shenzhen (CN); Li Liang, Shenzhen (CN)

(21) Appl. No.: 15/905,852

(22) Filed: Feb. 27, 2018

(30) Foreign Application Priority Data
Nov. 23, 2017 (CN) 201711182885.1

(51) Int. Cl. G05D 1/02; H04R 1/02; H04R 1/40; H04R 3/00

(52) U.S. Cl. CPC G05D 1/0225; G05D 1/0276; G05D 1/0242; G05D 1/0214; G05D 1/0255; H04R 1/028; B25J 9/1666; H04R 3/005; G05D 2201/0203; Y10S 901/01; Y10S 901/46; Y10S 901/49; H04R 1/406

(57) ABSTRACT

A guiding device to conduct a rechargeable device to a recharging station includes a motherboard and a microphone module. The microphone module is mounted on the motherboard and receives charging requests from the rechargeable device. The microphone module is configured to continuously transmit and update signals specifying a position of a predetermined charging area to the rechargeable device. The microphone module can identify a position of a sound source so as to guide the rechargeable device to the predetermined charging area. The microphone module can receive signals constituting charging request from any position throughout a full 360 degrees around the guiding device.

### CROSS REFERENCE TO RELATED APPLICATION

This application claims priority to Chinese Patent Application No. 201711182885.1 filed on Nov. 23, 2017, the disclosure of which is incorporated herein by reference in its entirety.

### FIELD

The present disclosure relates to controls for robots, and more particularly to a device for guiding a robot to an electrical recharging base.

### BACKGROUND

A robot such as a cleaning robot has the capability to move from one location to another to perform tasks at different locations. The robot can receive a signal from a recharging base and move to the recharging base to be automatically recharged. However, typically, the recharging base only generates a 180 degree signal coverage and the range of the robot for receiving signal is limited.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a perspective view of a guiding device.

FIG. 2 is an exploded perspective view of the guiding device of FIG. 1.

FIG. 3 is a schematic top view of the guiding device of FIG. 1.

FIG. 4 is a block diagram of a microphone module of the guiding device of FIG. 1.

FIG. 5 is a top view of a motherboard of the guiding device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

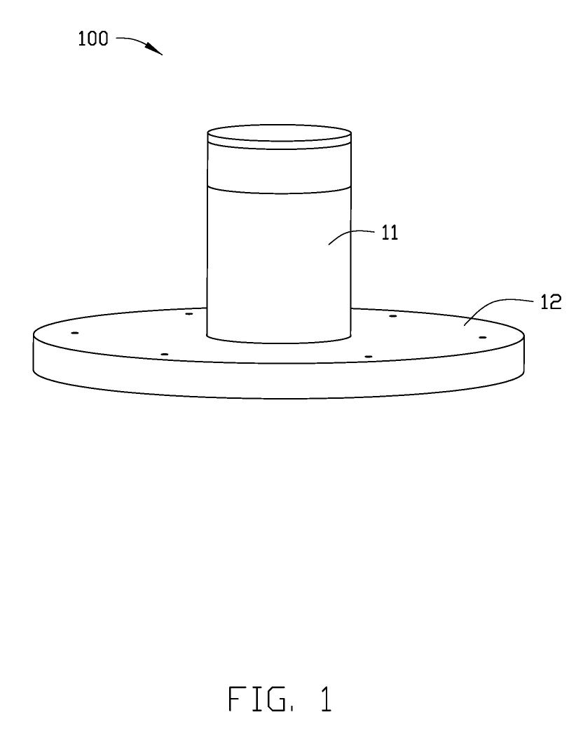

With reference to FIG. 1, an exemplary embodiment of a guiding device 100 is configured to guide a rechargeable device (not shown) to a recharging base to be automatically recharged. The rechargeable device may be a robot, such as a cleaning robot. The guiding device 100 includes a base 12 and a sensor unit 11. The guiding device 100 may further include components (not shown) for performing predetermined functions such as charging the rechargeable device.

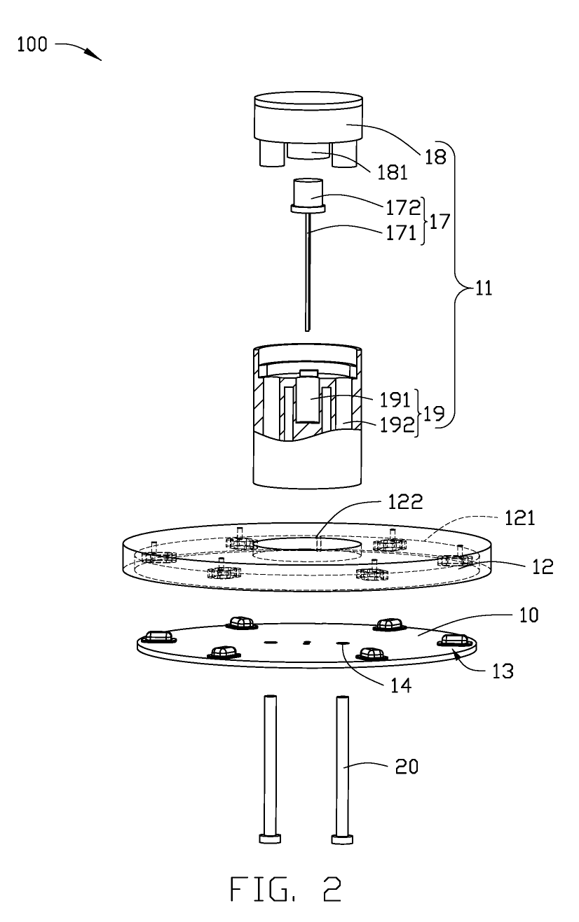

With reference to FIG. 2, the base 12 is disk-shaped. The base 12 includes a motherboard 10, and a microphone module 13. The base 12 has a bottom recess 121 and a central hole 122. The central hole 122 communicates with the bottom recess 121.

The motherboard 10 is disposed in the bottom recess 121 of the base 12. In the present exemplary embodiment, the motherboard 10 is circular, and the motherboard 10 has two screw holes 14. In other exemplary embodiments, the motherboard 10 may have other shapes.

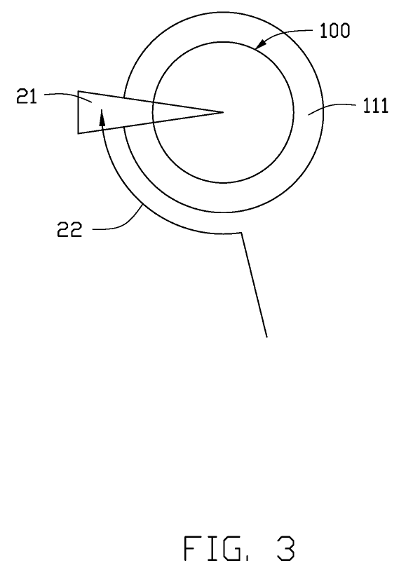

The microphone module 13 is mounted on the motherboard 10. The sensor unit 11 is mounted on the motherboard 10. The sensor unit 11 is configured to transmit and receive infrared signals. The sensor unit 11 transmits an infrared signal which is reflected by a floor surface to generate an infrared coverage area 111 (shown in FIG. 3), and receives the reflected infrared signal from the floor surface. The infrared coverage area 111 is a circular area centered on the guiding device 100, with a predetermined radius. The sensor unit 11 detects the rechargeable device entering the infrared coverage area 111 when the strength of the received reflected infrared signals vary, and the microphone module 13 may generate a warning. The rechargeable device includes an infrared detector. When the rechargeable device enters the infrared coverage area 111, the infrared detector detects the infrared signal and the rechargeable device can re-plan or re-route the movement path 22 away from the infrared coverage area 111. Thus, the rechargeable device is prevented from colliding with the guiding device 100 during movement.

In the present exemplary embodiment, the sensor unit 11 includes a holder 19, an infrared sensor 17, and an infrared lens 18. The holder 19 is mounted in the central hole 122 of the base 12. The holder 19 has a pin receiving hole 191 and two screw receiving holes 192. The two screw receiving holes 192 align with the two screw holes 14 in the motherboard 10. The infrared sensor 17 has a body 172 and a pin 171. The pin 171 is inserted in the pin receiving hole 191 in the holder 19. The infrared lens 18 has a cover portion 181 for covering the body 172 of the infrared sensor 17. Two screws 20 pass through the two screw holes 14 in the motherboard 10 and are threaded into the two screw receiving holes 192 in the holder 19 to secure the motherboard 10, the base 12, and the holder 19 together.

With further reference to FIG. 3, after receiving an acoustic charging request from the rechargeable device, the microphone module 13 is configured to calculate a position of the rechargeable device relative to a predetermined charging area 21 and continuously transmit acoustic signals guiding the rechargeable device to the predetermined charging area 21. The rechargeable device plans a movement path 22 to the predetermined charging area 21 according to the acoustic signals. While the rechargeable device is moving to the predetermined charging area 21, the rechargeable device transmits the acoustic charging request to the microphone module 13 at a predetermined time intervals. The microphone module 13 can calculate the position of the rechargeable device and transmit the updated acoustic signals. One or more acoustic sources may be in the predetermined charging area 21 to give prompts as to the position of the predetermined charging area 21.

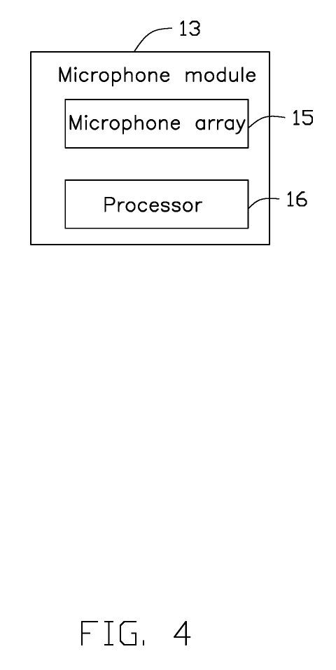

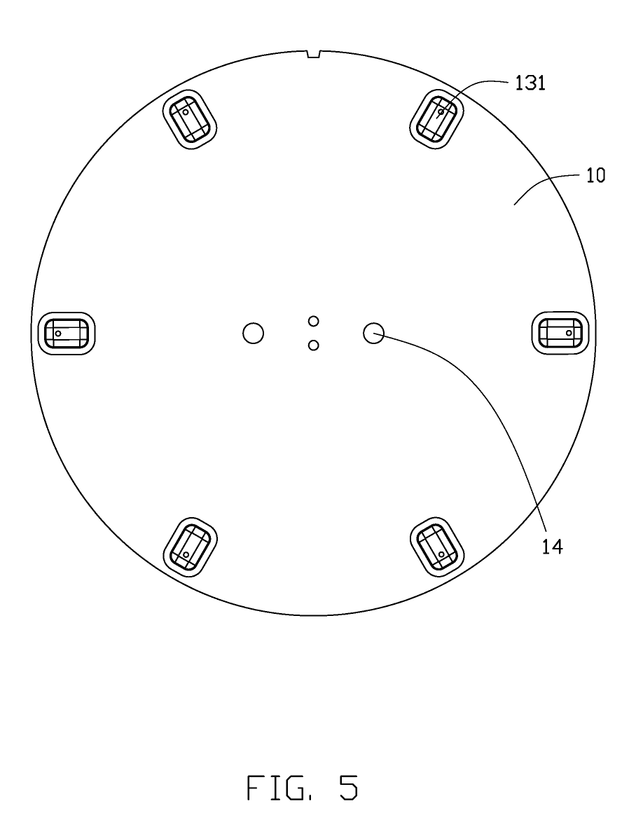

In the present exemplary embodiment, with reference to FIG. 4, the microphone module 13 includes a microphone array 15 and a processor 16. The microphone array 15 performs far-field noise suppression on the acoustic charging request, for good signal reception in a noisy environment. With further reference to FIG. 5, the microphone array 15 includes six microphones 131 circumferentially spaced at equal distances from each other on the motherboard 10. The processor 16 may be a microcontroller or an ARM (Advanced RISC Machine) processor. Each microphone 131 can receive the acoustic charging request from the rechargeable device. The orientation and times of the signals constituting the acoustic charging requests arriving at the six microphones 131 are different. The processor 16 can process the orientation and time data of the acoustic charging requests received by the microphones 131 and then calculate the position of the rechargeable device relative to the predetermined charging area 21. The microphones 131 can further continuously transmit the acoustic signals specifying the current position of the predetermined charging area 21 in relation to the rechargeable device.

The guiding device 100 employs the microphone module 13 to identify a position of a sound source from the rechargeable device, so as to guide the rechargeable device to the predetermined charging area 21. In addition, the microphone module 13 can receive the acoustic charging request from any position or locality throughout a full 360 degrees about the guiding device 100.

The exemplary embodiments shown and described above are only examples. Many details are often found in the art such as the other features of a recharging base for a robot. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A rechargeable device guiding device comprising:
a motherboard; and
a microphone module mounted on the motherboard, and the microphone module configured to, after receiving a charging request from the rechargeable device, continuously transmit signals guiding a rechargeable device to move to a predetermined charging area.

2. The guiding device of claim 1, wherein the microphone module is further configured to, after receiving a charging request from the rechargeable device, calculate a position of the rechargeable device relative to the predetermined charging area.

3. The guiding device of claim 1, wherein the microphone module comprises a microphone array comprising a plurality of microphones spaced at equal distances from each other on the motherboard.

4. The guiding device of claim 2, wherein the microphone module comprises a microphone array comprising a plurality of microphones spaced at equal distances from each other on the motherboard.

5. The guiding device of claim 3, wherein the plurality of microphones are configured to transmit acoustic signals specifying the position of the predetermined charging area to the rechargeable device.

6. The guiding device of claim 4, wherein the plurality of microphones are configured to transmit acoustic signals specifying the position of the predetermined charging area to the rechargeable device.

7. The guiding device of claim 1, further comprising a sensor unit generating an infrared coverage area.

8. The guiding device of claim 2, further comprising a sensor unit generating an infrared coverage area.

9. The guiding device of claim 3, further comprising a sensor unit generating an infrared coverage area.

10. The guiding device of claim 7, wherein the sensor unit comprises:
a holder;
an infrared sensor comprising:
a body; and
a pin inserted in the holder; and
an infrared lens comprising a cover portion for covering the body of the infrared sensor.

11. The guiding device of claim 8, wherein the sensor unit comprises:
a holder;
an infrared sensor comprising:
a body; and
a pin inserted in the holder; and
an infrared lens comprising a cover portion for covering the body of the infrared sensor.

12. The guiding device of claim 9, wherein the sensor unit comprises:
a holder;
an infrared sensor comprising:
a body; and
a pin inserted in the holder; and
an infrared lens comprising a cover portion for covering the body of the infrared sensor.

13. The guiding device of claim 10, wherein the microphone module generates a warning acoustic signal when the sensor unit detects that the rechargeable device enters the infrared coverage area.

14. The guiding device of claim 11, wherein the microphone module generates a warning acoustic signal when the sensor unit detects that the rechargeable device enters the infrared coverage area.

15. The guiding device of claim 12, wherein the microphone module generates a warning acoustic signal when the sensor unit detects that the rechargeable device enters the infrared coverage area.

16. The guiding device of claim 10, further comprising a base having a bottom recess in which the motherboard is disposed.

17. The guiding device of claim 11, further comprising a base having a bottom recess in which the motherboard is disposed.

18. The guiding device of claim 12, further comprising a base having a bottom recess in which the motherboard is disposed.

19. The guiding device of claim 16, wherein the base has a central hole in which the holder is mounted.

20. The guiding device of claim 17, wherein the base has a central hole in which the holder is mounted.
